(19) United States
(12) Patent Application Publication
(10) Pub. No.: US 2019/0030738 A1
(43) Pub. Date: Jan. 31, 2019

(54) RAZOR SYSTEMS AND METHOD

(71) Applicant: Brigitte Marleau, Sturgeon Falls (CA)

(72) Inventor: Brigitte Marleau, Sturgeon Falls (CA)

(21) Appl. No.: 16/050,055

(22) Filed: Jul. 31, 2018

Related U.S. Application Data
(60) Provisional application No. 62/539,441, filed on Jul. 31, 2017.

(51) Int. Cl. B26B 21/40; B26B 21/06; B26B 21/56; B26B 21/52; A45D 27/42; G09B 19/00

(52) U.S. Cl. CPC B26B 21/4043; B26B 21/06; B26B 21/56; A45D 2200/25; A45D 27/42; G09B 19/0076; B26B 21/522

(57) ABSTRACT

A razor system in a first version including: a razor assembly including a handle as a flexible shaft; and a head having at least one flexible blade; wherein the handle and the head are integrally combined; and wherein the at least one flexible blade has a total blade-length of ½ centimeter or less suitable for shaving lined-designs into the hair of an individual. Various versions of the product are available in straight blades and V-blades.

### CROSS-REFERENCE TO RELATED APPLICATIONS

This application is a non-provisional and claims benefit to U.S. Provisional Patent Application Ser. No. 62/539,441, filed Jul. 31, 2017, the disclosure of which is incorporated herein by reference in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of razors of existing art and more specifically relates to specialty razors.

### RELATED ART

Many Individuals like to shave. Shaving typically involves the removal of hair, by using a razor or any other kind of bladed implement, to slice it down, to the level of the skin or otherwise. Shaving is most commonly practiced by men to remove their facial hair and by women to remove their leg and underarm hair. Many children like to get their hair shaved in personalized versions to provide a personalized hair-cut. Getting shaving done at a hairdresser/barber can be expensive. A suitable solution is desired,

U.S. Pub. No. 2013/0247393 to Thomas Michael Poladian relates to a disposable safety razor. The described disposable safety razor includes a disposable razor having a razor blade with a width substantially narrower than that of any conventional disposable razors comprising of a rigid inner core handle for gripping, formed of thermoplastic material with a compatible rubber co-extrudable layer on the back side concave finger-rest and on the left and right side palm-rests. That portion of the razor blade that makes contact with the skin (the grind) has no encasing side borders allowing it to extend to within 0.7 millimeters (mm) of the sides of the razor's head. The rubberized portions on the handle provide for a secure grip in all shaving conditions including wet and soapy. The razor's symmetry, measured from the frontal center axis allows for the razor to be used with equal ease and effectiveness for a wide range of hand sizes whether the user is right or left handed.

### SUMMARY OF THE INVENTION

In view of the foregoing disadvantages inherent in the known razor art, the present disclosure provides a novel specialty razor system. The general purpose of the present disclosure, which will be described subsequently in greater detail, is to provide razors capable of providing home-hair shaving means suitable for fine definition shaving.

A razor system is disclosed herein in a first embodiment comprising: a razor assembly including a handle comprising a flexible shaft; and a head having at least one flexible blade; wherein the handle and the head are integrally combined; and wherein the at least one flexible blade comprises a total blade-length of ½ centimeter or less suitable for shaving lined-designs into hair of an individual. Various versions of the product are available in straight blades.

Another embodiment of the present invention comprises: a razor comprising a razor assembly comprising a handle comprising a flexible shaft; and a head having at least one (preferably two) flexible blade(s); wherein the handle and the head are also integrally combined. The flexible blades each comprise a total blade-length of ½ centimeter or less suitable for shaving lined-designs into the hair of an individual. The razor is disposable in preferred embodiments. The at least one flexible blade comprises a top-blade and a bottom-blade; wherein the top-blade is located above the bottom-blade during use (when held vertically for shaving). These blades are preferably V-shaped with a top-V-blade being located above a bottom-V-blade during use. The top-blade is longer (has a blade-length greater) than the bottom-blade. Each V-blade comprises an apex; wherein at least one cutting-edge is located progressing to the apex. The head used to mount the V-blades is a u-shape; wherein sides of the u-shape each comprise an outward angle to accommodate the blades. Relationally speaking the top-blade and the bottom-blade (cutting edges) run non-parallel to the handle. In this embodiment the top-blade and the bottom-blade each comprise a corner-blade. A kit is also described herein further comprising set of instructions; and wherein the razors are arranged as a kit for home use with a disposable marker and stencils.

According to another embodiment, a razor system is also disclosed herein. The use of the razor(s) includes a step(s) of providing a razor comprising: a razor assembly comprising a handle comprising a flexible shaft; and a head having at least one flexible blade; wherein the handle and the head are integrally combined; and wherein the at least one flexible blade comprises a total blade-length of ½ centimeter or less suitable for shaving lined-designs into hair of an individual; wherein the razor is disposable; and using the at least one flexible blade comprising a total blade-length of ½ centimeter or less suitable for shaving lined-designs into hair of an individual. The method may further comprise the step of using a razor wherein a top-V-blade is located above a bottom-V-blade during use. The razors described herein may be used in various combinations to provide a desired hair design. The disposable marker and stencil may be used to draw the desired hair trim and the appropriate razor(s) used to shave the marked hair.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a razar system, constructed and operative according to the teachings of the present disclosure.

FIG. 1 is a perspective view of the razar system during an ‘in-use’ condition, according to an embodiment of the disclosure.

FIG. 2 is a perspective view of the razar system of FIG. 1, according to an embodiment of the present disclosure.

FIG. 3 is a perspective view of the razar system of FIG. 1, according to an embodiment of the present disclosure.

FIG. 4 is a perspective view of the razar system of FIG. 1, according to an embodiment of the present disclosure.

FIG. 5 is a flow diagram illustrating a method of use for the razar system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to razor and more particularly to a razar system as used to improve the trimming of hair.

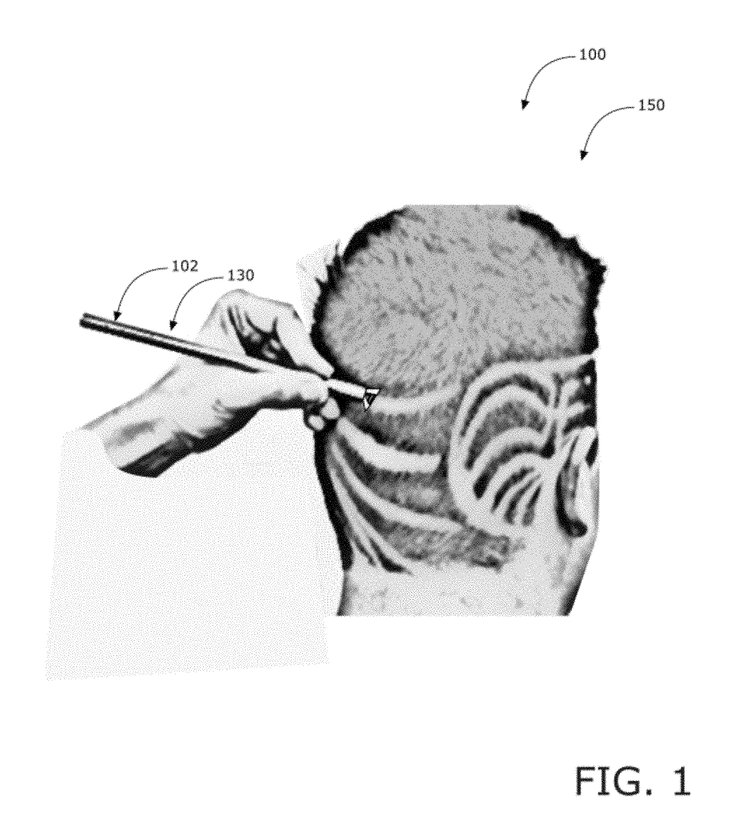

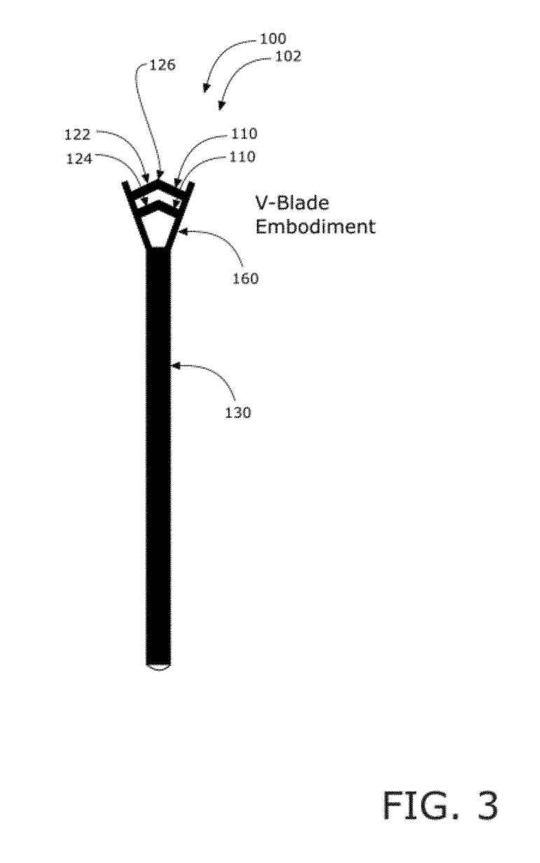

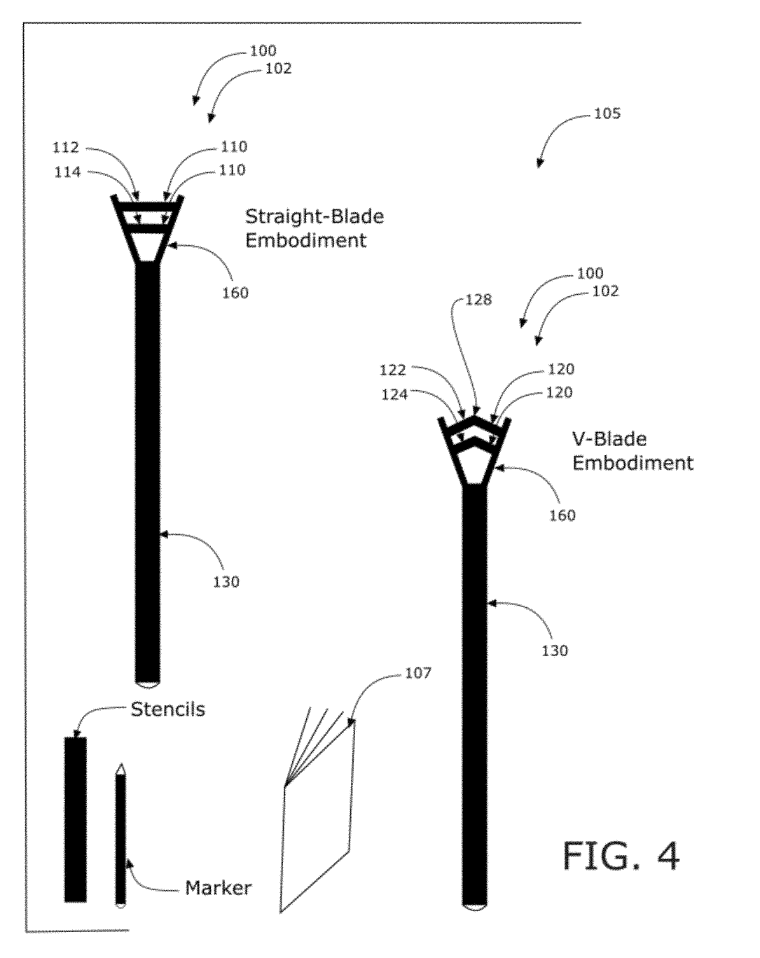

Referring now more specifically to the drawings by numerals of reference, there is shown in FIGS. 1-4, various views of a razar system 100.

FIG. 1 shows a razar system 100 during an ‘in-use’ condition 150, according to an embodiment of the present disclosure. Here, the razar system 100 may be beneficial for use by a user hairdresser or the like to provide desired and defined hair shaving tasks. As illustrated, the razar system 100 may include a razor assembly comprising a handle 130 comprising a flexible shaft; and a head 160 having at least one flexible blade 110; wherein the handle 130 and the head 160 are integrally combined in preferred embodiments; and wherein the at least one flexible blade 110 comprises a total blade-length of ½ centimeter or less suitable for shaving lined-designs into the hair of an individual. Upon reading this specification, it should be appreciated that, under appropriate circumstances, considering such issues as user preferences, design preference, structural requirements, marketing preferences, cost, available materials, technological advances, etc., other razar structural arrangements such as, for example, removable heads, different alignment of the blades, different cutting edges, different blade shapes, different numbers of blades, etc., may be sufficient.

According to one embodiment, the razar system 100 may be arranged as a kit 105. In particular, the razar system 100 may further include a set of instructions 107. The instructions 107 may detail functional relationships in relation to the structure of the razar system 100 such that the razar system 100 can be used, maintained, or the like, in a preferred manner. The kit 105 is preferably sold with a disposable marker and stencils such that the user can shave the hair by following marked designs. Both embodiments of the razor 102 may be sold within the kit 105.

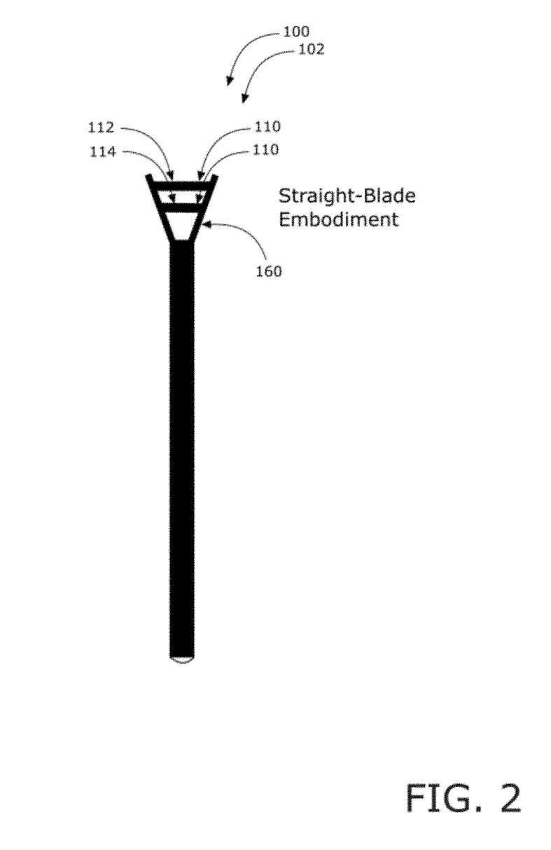

FIGS. 2-4 shows various views of different embodiments of the razar system 100 of FIG. 1. As above, the razar system 100 may include the razor 102; wherein the razor 102 is disposable. The at least one flexible blade 110 preferably comprises a top-blade 112 and a bottom-blade 114; wherein the top-blade 112 is located above the bottom-blade 114 during use and the top-blade 112 and the bottom-blade 114 are horizontally parallel and each are straight-blades in certain embodiments. The top-blade 112 and the bottom-blade 114 are horizontally parallel in straight-blade embodiments.

Other embodiments may comprise blades on different orientations, as also shown. The top-blade 112 is longer than the bottom-blade 114. Certain versions may comprise the top-blade 112 and the bottom-blade 114 being equal in length. Straight blade embodiments are shown as are V-blade 120 embodiments.

Referring now to V-blade 120 embodiments; V-blade 120 embodiments each comprise an apex 126 on the V-blade 120. The top-V-blade 122 is located above a bottom-V-blade 124 during use. The at least one cutting-edge in these particular embodiments is located progressing to the apex 126. In certain embodiments the head 160 is a u-shape; wherein sides of the u-shape each comprise an outward angle to accommodate proper and durable mounting for the blade(s). The cutting edge is perpendicular to the handle 130 and inline with and on the flexible blade 110. The at least one cutting-edge runs parallel to the blade and non-parallel to the handle 130, as shown. The top-V-blade 122 and the bottom-V-blade 124 each comprise a corner-blade 128 in V-blade versions. The angle of the cutting edge in relation to the handle 130 provide for comfort and precision when shaving. Those with ordinary skill in the art will now appreciate that upon reading this specification and by their understanding the art of blades and cutting edges as described herein, methods of orientation and use will be understood by those knowledgeable in such art. In certain embodiments the blades may run parallel to the handle 130.

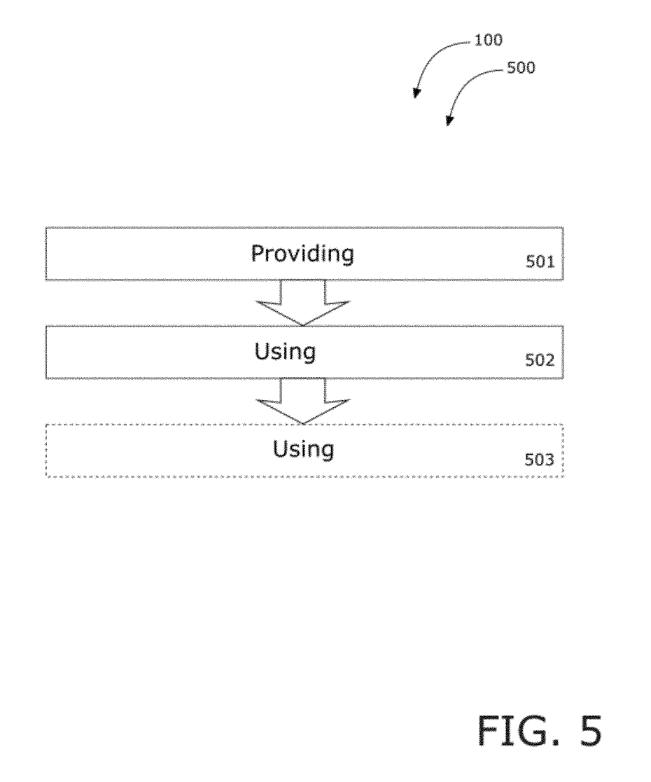

FIG. 5 is a flow diagram illustrating a method of use for the razor system 100, according to an embodiment of the present disclosure. In particular, the method of use 500 may include one or more components or features of the razor system 100 as described above. As illustrated, the method for razor system 100 may include the steps of: step one 501, providing at least one razor comprising: a razor assembly including a handle comprising a flexible shaft; and a head having at least one flexible blade; wherein the handle and the head are integrally combined; and wherein the at least one flexible blade comprises a total blade-length of ½ centimeter (or less) suitable for shaving fine-lined-designs into hair of an individual; wherein the razor is disposable; step two 502, using the at least one flexible blade comprising a total blade-length of ½ centimeter or less suitable for shaving lined-designs into the hair of an individual. The flexible blade (straight blade version) and the V-blade version may be used separately or in combination of the razor system 100. Further steps may include 503 use of the disposable marker in combination with a stencil to provide marking means by which to follow for shaving using the razor system 100.

It should be noted that step 503 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for fine-line shaving, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A razor comprising:
a razor assembly including;
a handle comprising a flexible shaft; and
a head having at least one flexible blade;
wherein the handle and the head are integrally combined; and
wherein the at least one flexible blade comprises a total blade-length of ½ centimeter or less suitable for shaving lined-designs into hair of an individual.

2. The razor of claim 1, wherein the razor is disposable.

3. The razor of claim 2, wherein the at least one flexible blade comprises a top-blade and a bottom-blade.

4. The razor of claim 3, wherein the top-blade is located above the bottom-blade during use.

5. The razor of claim 4, wherein the top-blade and the bottom-blade are horizontally parallel, and each are straight-blades.

6. The razor of claim 5, wherein the top-blade is longer than the bottom-blade.

7. The razor of claim 3, wherein the top-blade and the bottom-blade each comprise a V-blade.

8. The razor of claim 7, wherein each said V-blade comprises an apex.

9. The razor of claim 1, wherein a top-V-blade is located above a bottom-V-blade during use.

10. The razor of claim 8, wherein at least one cutting-edge is located progressing to the apex.

11. The razor of claim 1, wherein the head is a u-shape.

12. The razor of claim 11, wherein sides of the u-shape each comprise an outward angle.

13. The razor of claim 5, wherein the top-blade and the bottom-blade run perpendicular to the handle.

14. The razor of claim 7, wherein the top-blade and the bottom-blade run non-parallel to the handle.

15. The razor of claim 10, wherein the at least one cutting-edge runs non-parallel to the blade.

16. The razor of claim 15, wherein the top-blade and the bottom-blade each comprise a corner-blade.

17. A razor comprising:
a razor assembly comprising;
a handle comprising a flexible shaft; and
a head having at least one flexible blade;
wherein the handle and the head are integrally combined;
wherein the at least one flexible blade comprises a total blade-length of ½ centimeter or less suitable for shaving lined-designs into hair of an individual;
wherein the razor is disposable;
wherein the at least one flexible blade comprises a top-blade and a bottom-blade;
wherein the top-blade is located above the bottom-blade during use;
wherein a top-V-blade is located above a bottom-V-blade during use;
wherein the top-blade is longer than the bottom-blade;
wherein the top-blade and the bottom-blade each comprise a V-blade;
wherein each said V-blade comprises an apex;
wherein at least one cutting-edge is located progressing to the apex;
wherein the head is a u-shape;
wherein sides of the u-shape each comprise an outward angle;
wherein the top-blade and the bottom-blade do not run parallel to the handle; and
wherein the top-blade and the bottom-blade each comprise a corner-blade.

18. The razor of claim 17, further comprising set of instructions; and
wherein the razor is arranged as a kit with a disposable marker and stencils.

19. A method of use for a razor, the method comprising the steps of:
providing a razor comprising:
a razor assembly comprising;
a handle comprising a flexible shaft; and
a head having at least one flexible blade;
wherein the handle and the head are integrally combined; and
wherein the at least one flexible blade comprises a total blade-length of ½ centimeter or less suitable for shaving lined-designs into hair of an individual;
wherein the razor is disposable; and
using the at least one flexible blade comprises a total blade-length of ½ centimeter or less suitable for shaving said lined-designs into the hair of said individual.

20. The method of claim 19, wherein the at least one flexible blade comprises a top-V-blade located above a bottom-V-blade during use.
